(19) United States
(12) Patent Application Publication
(10) Pub. No.: US 2025/0309309 A1
(43) Pub. Date: Oct. 2, 2025

(54) CELL UNIT MANUFACTURING METHOD FOR FUEL CELL AND CELL UNIT MANUFACTURING APPARATUS FOR FUEL CELL

(71) Applicant: Honda Motor Co., Ltd., Tokyo (JP)

(72) Inventor: Yuta Oshima, Saitama (JP)

(21) Appl. No.: 19/063,216

(22) Filed: Feb. 25, 2025

(30) Foreign Application Priority Data
Mar. 29, 2024 (JP) 2024-058108

(51) Int. Cl. H01M 8/242; H01M 4/88; H01M 8/0273; H01M 8/1004; H01M 8/2404

(52) U.S. Cl. CPC H01M 8/242; H01M 4/881; H01M 8/0273; H01M 8/1004; H01M 8/2404; H01M 2250/20

(57) ABSTRACT

A cell unit manufacturing method for a fuel cell including disposing a membrane electrode structure of a cell unit above an upper surface of a table by engaging or fitting a positioned portion provided on an outer edge of a frame member of the membrane electrode structure with a positioning member formed in a rod shape, the positioning member being protruding movably upward and downward from the upper surface of the table; mounting a positioning frame on the positioning member to push the positioning member while positioning the positioning frame using the positioning member; mounting the separator on the membrane electrode structure while positioning an outer edge of a separator of the cell unit using a positioning portion provided on the positioning frame; and welding the membrane electrode structure and the separator in a state where the membrane electrode structure and the separator are positioned.

### CROSS-REFERENCE TO RELATED APPLICATION

This application is based upon and claims the benefit of priority from Japanese Patent Application No. 2024-058108 filed on Mar. 29, 2024, the content of which is incorporated herein by reference.

### BACKGROUND OF THE INVENTION

### Field of the Invention

This invention relates to a cell unit manufacturing method for a fuel cell and a cell unit manufacturing apparatus for a fuel cell for manufacturing a cell unit by joining together a membrane electrode structure and a separator.

### Description of the Related Art

In recent years, technological developments have been made on a fuel cell that contribute to energy efficiency in order to ensure access to energy that is affordable, reliable, sustainable and advanced by more people. As a conventional technology related to a fuel cell stack used in this type of fuel cell, there is a known method in which a resin frame member of a membrane electrode structure and a separator are pre-integrated through welding, and the integrated cells are stacked to form a cell stacked body. Such method is described, for example, in Japanese Examined Patent Publication No. 7062729 (JP 7062729 B). In the method described in JP 7062729 B, the positioning holes of the membrane electrode structure and the separator are inserted to a tapered positioning pin protruding from the base to position, and a laser beam is irradiated to weld and join them in a positioned state.

However, in the method described in JP 7062729 B, since the membrane electrode structure is provided with a positioning portion (e.g., a positioning hole) for welding on a thin resin frame member, dimensional tolerances or other factors may cause interference between the positioning portion and the positioning member, potentially damaging the resin frame member during cell unit manufacturing.

### SUMMARY OF THE INVENTION

An aspect of the present invention is a cell unit manufacturing method for a fuel cell, a cell unit being configured by joining together a membrane electrode structure and a separator, the membrane electrode structure including a membrane electrode assembly having an electrolyte membrane and an electrode, and a frame member being made of resin and configured to support the membrane electrode assembly. The cell unit manufacturing method includes: disposing the membrane electrode structure above an upper surface of a table by engaging or fitting a positioned portion provided on an outer edge of the frame member with a positioning member formed in a rod shape, the positioning member being protruding movably upward and downward from the upper surface of the table; mounting a positioning frame on the positioning member to push the positioning member while positioning the positioning frame using the positioning member; mounting the separator on the membrane electrode structure while positioning an outer edge of the separator using a positioning portion provided on the positioning frame; and welding the membrane electrode structure and the separator in a state where the membrane electrode structure and the separator are positioned.

Another aspect of the present invention is a cell unit manufacturing apparatus for a fuel cell, a cell unit being configured by joining together a membrane electrode structure and a separator, the membrane electrode structure including a membrane electrode assembly having an electrolyte membrane and an electrode, and a frame member being made of resin and configured to support the membrane electrode assembly. The cell unit manufacturing apparatus includes: a table including an upper surface onto which the membrane electrode structure is disposed, and a positioning member formed in a rod shape, the positioning member being protruding from the upper surface so that a positioned portion provided on an outer edge of the frame member is engaged or fitted with the positioning member; and a positioning frame including an abutting portion abutting on the positioning member and positioned by the positioning member, and a positioning portion configured to position the separator, the positioning frame being mounted on the positioning member through the abutting portion. The table further includes a support portion supporting the positioning member so as to allow vertical movement so that the positioning member lowers when the positioning frame is mounted through the abutting portion.

### BRIEF DESCRIPTION OF THE DRAWINGS

The objects, features, and advantages of the present invention will become clearer from the following description of embodiments in relation to the attached drawings, in which:

FIG. 1 is a perspective view schematically showing an overall configuration of a fuel cell stack including a cell unit manufactured using a cell unit manufacturing method for a fuel cell according to the embodiment of the present invention;

FIG. 2 is a cross-sectional view showing a configuration of a main part in a power generation region of a cell stacked body included in the fuel cell stack in FIG. 1;

FIG. 3 is an exploded perspective view of the cell unit included in the fuel cell stack in FIG. 1;

FIG. 4A is a perspective view illustrating a schematic configuration of a cell unit manufacturing apparatus for a fuel cell according to an embodiment of the present invention;

FIG. 4B is an enlarged view of a portion B in FIG. 4A;

FIG. 5A is a perspective view of a table included in the manufacturing apparatus in FIG. 4A;

FIG. 5B is a perspective view illustrating a state in which a unitized electrode assembly is mounted on an upper surface of the table in FIG. 5A;

FIG. 6 is a cross-sectional view taken along line VI-VI of FIG. 5A;

FIG. 7 is a cross-sectional view taken along line VII-VII of FIG. 4B;

FIG. 8 is a diagram illustrating an example of an operation of the cell unit manufacturing apparatus for the fuel cell according to the embodiment of the present invention; and

FIG. 9 is a diagram illustrating a welding process included in the cell unit manufacturing method for the fuel cell according to the embodiment of the present invention.

### DETAILED DESCRIPTION OF THE INVENTION

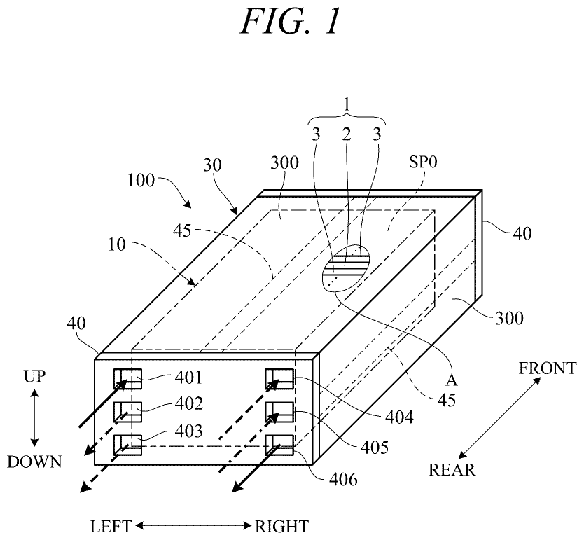

Hereinafter, an embodiment of the present invention will be described with reference to FIGS. 1 to 9. A fuel cell stack according to an embodiment of the present invention is a main component of a fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

First, an overall configuration of the fuel cell stack will be schematically described. FIG. 1 is a perspective view schematically showing an overall configuration of a fuel cell stack 100 including a cell unit manufactured using a cell unit manufacturing method for a fuel cell according to the embodiment of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. These directions may be different from a front-rear direction, a left-right direction, and an up-down direction of the vehicle. The front-rear direction in FIG. 1 is a stacking direction of the fuel cell stack 100, and when assembling the fuel cell stack 100, the stacking direction is aligned with the direction of gravity.

As illustrated in FIG. 1, the fuel cell stack 100 includes a cell stacked body 10, end units 40 disposed on both ends in the front-rear direction of the cell stacked body 10, and a case 30 surrounding the cell stacked body 10, and the whole of the fuel cell stack 100 has a substantially rectangular parallelepiped shape. The length of the fuel cell stack 100 in the left-right direction is longer than the length in the up-down direction.

The case 30 has four substantially rectangular side walls 300, each facing the top, right, bottom, and left surfaces of the cell stacked body 10. These four side walls 300 form a substantially box-shaped housing space SP0 with open the front and rear surfaces. The case 30 is composed of metals such as aluminum or iron.

In part “A” of FIG. 1, a portion of the side wall 300 of the case 30 is shown as broken. As illustrated in part “A” of FIG. 1, the cell stacked body 10 is a stacked body including a plurality of power generation cells 1 (for convenience, only a single cell 1 is illustrated) disposed in the housing space SP0.

The power generation cell 1 has a unitized electrode assembly (hereinafter, referred to as a “UEA”) 2 including a membrane electrode assembly having an electrolyte membrane and an electrode, and separators 3 arranged on both front and rear sides of the UEA 2 to sandwich the UEA 2. The UEA 2 and the separator 3 are alternately arranged in the front-rear direction. The UEA 2 can also be referred to as a membrane electrode structure or a membrane electrode member. In the central part in the left-right direction and in the central part in the up-down direction of the power generation cell 1, a power generation region is formed where electricity is generated through the electrochemical reaction of hydrogen and oxygen.

A plurality of guide members 45 (only partially shown) are interposed between the cell stacked body 10 and side walls 300 of the case 30. The guide member 45 is a rod-like or plate-like member extending in the front-rear direction, and is attached in advance to the inner surface of the side wall 300. The guide member 45 is previously attached to each of the inner surfaces of the four side walls 300 (the inner wall of the case 30), and the cell stacked body 10 is assembled in this state. During assembly of the fuel cell stack 100, for example, the rear end unit 40 is laid sideways, and a plurality of power generation cells 1 guided by the guide members 45 are stacked thereon to assemble the cell stacked body 10. Then, the front end unit 40 is mounted on the cell stacked body 10.

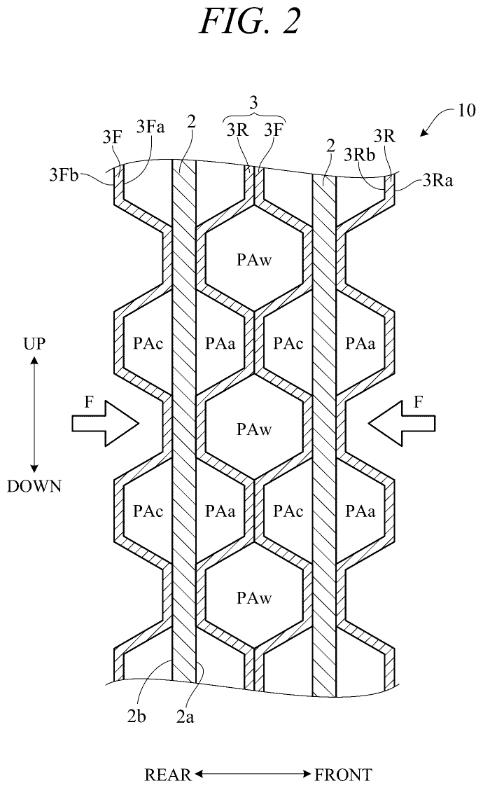

FIG. 2 is a cross-sectional view showing a configuration of a main part in the power generation region of the cell stacked body 10, and more specifically, it is a cross-sectional view cut along a plane extending in the up-down and front-rear directions. As shown in FIG. 2, the separator 3 has a front plate 3F and a rear plate 3R, which are a pair of metal thin plates with a corrugated cross-section. The front plate 3F extends in the up-down and left-right directions and has a front surface 3Fa and a rear surface 3Fb. The rear plate 3R extends in the up-down, and left-right directions, and has a front surface 3Ra and a rear surface 3Rb.

The rear surface 3Fb of the front plate 3F and the front surface 3Ra of the rear plate 3R facing each other are joined together by welding or the like at their outer peripheral edges. Thus, the front plate 3F and the rear plate 3R are integrally joined to form a separator 3. The separator 3 uses a conductive material with excellent corrosion resistance, such as stainless steel, titanium, or titanium alloy.

Inside the separator 3 enclosed by the front plate 3F and the rear plate 3R, that is, between the rear surface 3Fb of the front plate 3F and the front surface 3Ra of the rear plate 3R, a cooling flow path PAw through which a cooling flows is formed. The generating surface of the power generation cell 1 is cooled by the flow of the cooling medium. Water, for example, can be used as the cooling medium. The surfaces of the separator 3 facing the UEA 2, that is, the front surface 3Fa of the front plate 3F and the rear surface 3Rb of the rear plate 3R, are formed into an uneven shape by press molding or the like to form a gas flow path between the separator 3 and the UEA 2.

More specifically, between the front surface 2a of the UEA 2 and the rear plate 3R of the separator 3 facing this front surface 2a, an anode flow path PAa through which fuel gas including hydrogen (anode gas) flows is formed. Between the rear surface 2b of the UEA 2 and the front plate 3F of the separator 3 facing this rear surface 2b, a cathode flow path PAc through which oxidant gas including oxygen (cathode gas) flows is formed. The fuel gas and the oxidant gas may be referred to as a reaction gas without being distinguished from each other. In the cell stacked body 10, a compressive load F is applied in the front-rear direction during the assembly of the fuel cell stack 100. After the assembly of the fuel cell stack 100 is completed, the pair of front and rear end units 40 are fastened to the case 30, thereby maintaining the compressive load F.

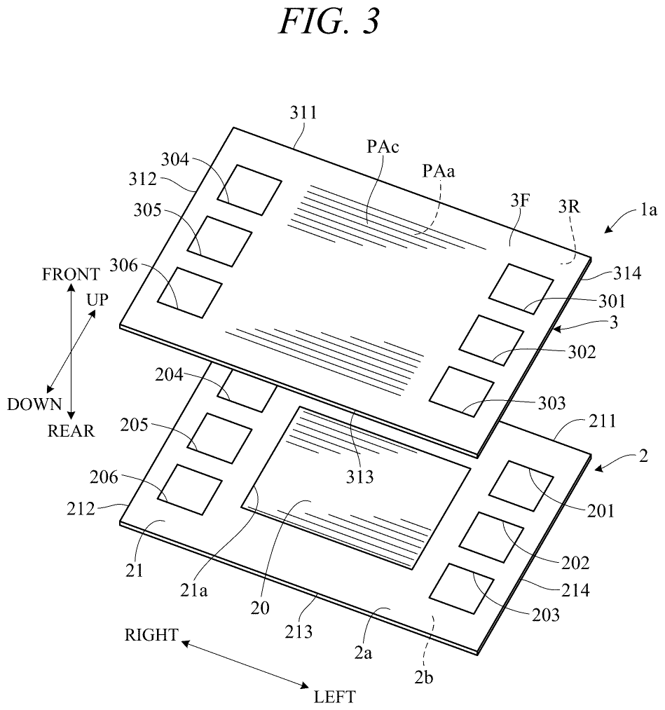

A single UEA 2 and a single separator 3 are integrally joined in advance by welding, more specifically, by thermal bonding, to form a cell unit (a unit cell). FIG. 3 is an exploded perspective view of the cell unit 1a showing the schematic configuration of the UEA 2 and the separator 3. The cell unit 1a is formed by joining the pair of plates 3F and 3R to form the separator 3, and then, for example, overlaying the rear plate 3R of the separator 3 on the front surface 2a of the UEA 2. Although not shown in FIG. 3, a positioning portion for positioning during welding is provided on an outer edge portions of the UEA 2 and the separator 3.

As shown in FIG. 3, the UEA 2 includes a substantially rectangular membrane electrode assembly 20 (hereinafter, referred to as a “MEA”) and a frame 21 that supports the MEA 20. The MEA 20 has an electrolyte membrane, an anode electrode provided on a front surface of the electrolyte membrane, and a cathode electrode provided on a rear surface of the electrolyte membrane. The electrolyte membrane is, for example, a solid polymer electrolyte membrane. The anode electrode has an electrode catalyst layer formed on the front surface of the electrolyte membrane and served as a reaction field for electrode reaction, and a gas diffusion layer formed on the front surface of the electrode catalyst layer to spread and supply the fuel gas. The cathode electrode has an electrode catalyst layer formed on the rear surface of the electrolyte membrane and served as a reaction field for electrode reaction, and a gas diffusion layer formed on the rear surface of the electrode catalyst layer to spread and supply the oxidant gas.

In the anode electrode, the fuel gas (hydrogen) supplied through the anode flow path PAa (FIG. 2) and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path PAc (FIG. 2) and the gas diffusion layer reacts with hydrogen ions guided from the anode electrode and electrons moved from the anode electrode to generate water. The generated water gives an appropriate humidity to the electrolyte membrane, and excess water is discharged to an outside of the UEA 2.

The frame 21 is a film-shaped member having a substantially rectangular shape, with its outer edge formed by four sides (upper side 211, right side 212, lower side 213, and left side 214). The frame 21 is made of an insulating material such as resin or rubber. A substantially rectangular opening 21a is provided in a central portion of the frame 21. The MEA 20 is disposed to cover the entire opening 21a and a peripheral portion of the MEA 20 is supported by the frame 21. Three through-holes 201 to 203 penetrating the frame 21 in the front-rear direction are opened side by side in the up-down direction on the left side of the opening 21a of the frame 21. Three through-holes 204 to 206 penetrating the frame 21 in the front-rear direction are opened side by side in the up-down direction on the right side of the opening 21a of the frame 21.

The separator 3 has a substantially rectangular shape overall, with its outer edge formed by four sides (upper side 311, right side 312, lower side 313, and left side 314). The separator 3 forms uneven cathode flow paths PAc (FIG. 2) and uneven anode flow paths PAa (FIG. 2) on the front and rear surfaces facing the MEA 20, respectively. In the separator 3, through-holes 301 to 306 penetrating the separator 3 in the front-rear direction are opened at positions corresponding to the through-holes 201 to 206 of the frame 21. The through-holes 301 to 306 communicate with the through-holes 201 to 206 of the frame 21, respectively. The set of these through-holes 201 to 206, 301 to 306, which communicate with each other, forms a plurality of flow paths penetrating the cell stacked body 10 and extending in the front-rear direction.

As shown in FIG. 1, in the rear end unit 40, a plurality of through-holes 401 to 406 penetrating the end unit 40 in the front-rear direction are opened at positions corresponding to the through-holes 201 to 206 and 301 to 306. In the front end unit 40, the through-holes 401 to 406 are not opened.

A fuel gas tank storing high-pressure fuel gas is connected to the through-hole 401 via an ejector, an injector, etc., and the fuel gas is supplied to the fuel cell stack 100 through the through-hole 401, as shown by a solid arrow. This fuel gas is guided to the anode flow path PAa through the through-holes 201 and 301. The fuel gas after passing through the anode flow path PAa is discharged from the through-hole 406 through the through-holes 206 and 306, as shown in a solid arrow.

A compressor for supplying oxidant gas is connected to the through-hole 404, and the oxidant gas compressed by the compressor is supplied to the fuel cell stack 100 through the through-hole 404, as shown in a dotted arrow. This oxidant gas is guided to the cathode flow path PAc through the through-holes 204 and 304. The oxidant gas after passing through the cathode flow path Pac is discharged from the through-hole 403 through the through-holes 203 and 303, as shown in a dotted arrow.

A pump for supplying cooling medium is connected to the through-hole 405, and the cooling medium is supplied to the fuel cell stack 100 through the through-hole 405, as shown in a chain arrow. This cooling medium is guided to the cooling flow path PAw between the front plate 3F and the rear plate 3R of the separator 3 through the through-holes 205 and 305. The cooling medium after passing through the cooling flow path PAw is discharged from the through-hole 402 through the through-holes 202 and 302, as shown in a chain arrow.

A schematic configuration of the fuel cell stack 100 has been described above. The present embodiment is characterized in that the cell unit 1a is manufactured by integrating the single UEA 2 and the single separator 3 in advance, that is, the cell unit manufacturing process. Hereinafter, such a case will be described.

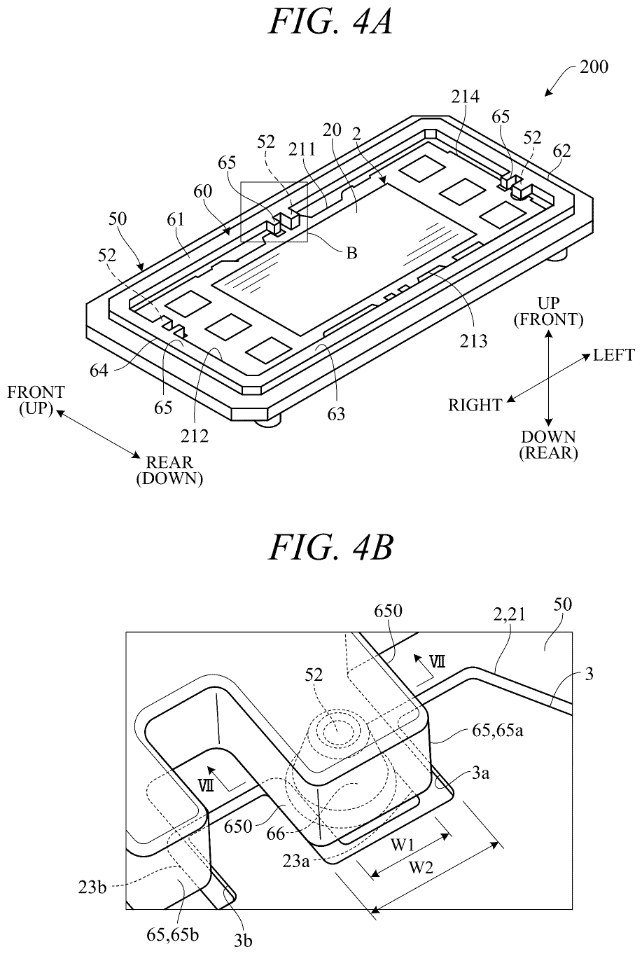

The cell unit 1a is manufactured using a manufacturing apparatus. FIG. 4A is a perspective view illustrating a schematic configuration of the manufacturing apparatus 200, and illustrates a state in the middle of cell unit manufacturing processing. In the description of the manufacturing processing, directions corresponding to the up-down direction and the front-rear direction in FIG. 1 are defined as the front-rear direction and the up-down direction, respectively, as illustrated in FIG. 4A. The lower side (rear side in FIG. 1) in the up-down direction in FIG. 4A corresponds to the gravity direction. As illustrated in FIG. 4A, the manufacturing apparatus 200 includes a table 50 on which the UEA 2 is placed and a border frame (frame-shaped frame) 60 mounted on the table 50.

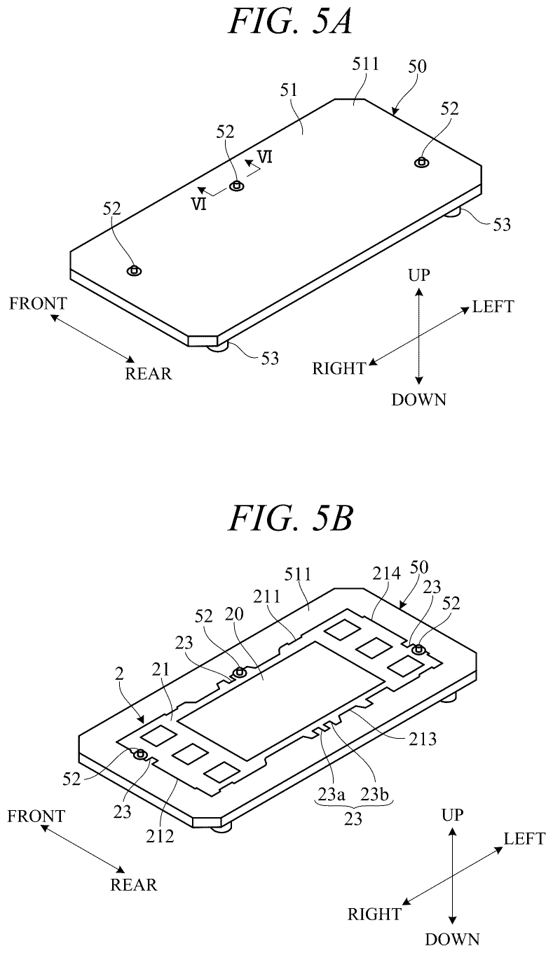

FIG. 5A is a perspective view of the table 50. As illustrated in FIG. 5A, the table 50 includes a plate 51 having a substantially rectangular shape in plan view, and a plurality of positioning pins 52 protruding from an upper surface 511 of the plate 51. Legs 53 are provided on a lower surface of the plate 51. The positioning pins 52 are provided at positions corresponding to positioning portions of the UEA 2. Specifically, the positioning pins 52 are provided in the vicinity of the front end portion of the plate 51 and at the central portion in the left-right direction, in the vicinity of the left end portion of the plate 51 and behind the central portion in the front-rear direction, and in the vicinity of the right end portion of the plate 51 and ahead of the central portion in the front-rear direction. The configurations of the plurality of positioning pins 52 are the same as each other. The positions and the number of positioning pins 52 are not limited to those illustrated in FIG. 5A.

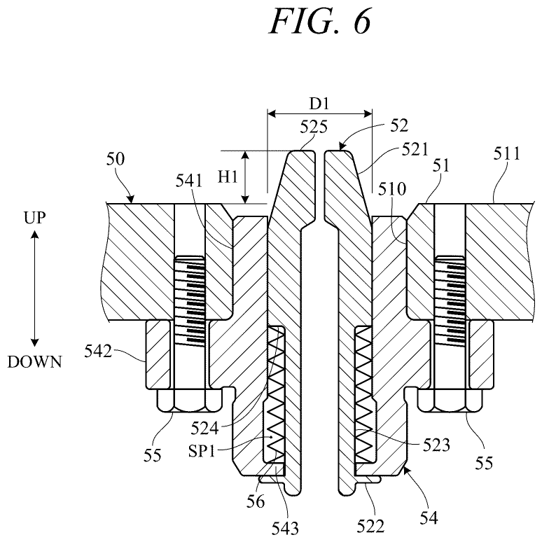

FIG. 6 is a cross-sectional view taken along line VI-VI of FIG. 5A. As illustrated in FIG. 6, the positioning pin 52 is supported by a holder 54 so as to be movable up and down. The holder 54 includes a peripheral wall portion 541 having a substantially cylindrical shape and a flange portion 542 protruding outward from an outer peripheral surface of the peripheral wall portion 541. A through-hole 510 that has a substantially circular shape and penetrates the plate 51 in the up-down direction is formed in the plate 51. The peripheral wall portion 541 of the holder 54 is inserted into the through-hole 510 from below the plate 51, and in this state, the flange portion 542 is fastened to a lower surface 512 of the plate 51 with a bolt 55. At this time, the upper end portion of the peripheral wall portion 541 is positioned below the upper surface 511 of the table 50 (plate 51). A spring seat 543 protruding radially inward is provided at a lower end portion of the peripheral wall portion 541.

The positioning pin 52 has a substantially cylindrical shape as a whole, and is inserted inside the peripheral wall portion 541 of the holder 54 so as to be movable up and down along the inner peripheral surface of the peripheral wall portion 541. The upper end portion of the positioning pin 52 has a substantially conical tapered portion 521 formed to narrow upward. The tapered portion 521 protrudes upward from the upper surface 511 of the table 50. A stopper 522 protruding radially outward is provided at the lower end portion of the positioning pin 52. The stopper 522 is positioned below the spring seat 543 of the holder 54. The positioning pin 52 has a small diameter portion 523 in which the diameter of the outer peripheral surface is decreased via a step portion 524 from the stopper 522 to the upper side by a predetermined length. There is an annular space SP1 between the outer peripheral surface of the small diameter portion 523 and the inner peripheral surface of the peripheral wall portion 541, and a spring (for example, a coil spring) 56 is interposed in the space SP1.

The upper end portion of the spring 56 abuts on the step portion 524 of the positioning pin 52, and the lower end portion of the spring 56 abuts on the spring seat 543 of the holder 54. The spring 56 is a compression spring and biases the positioning pin 52 upward via the step portion 524. In an initial state in which no downward pressing force acts on the positioning pin 52, the stopper 522 of the positioning pin 52 abuts on the spring seat 543, and the length from the upper surface 511 of the table 50 to an upper end surface 525 of the positioning pin 52, that is, the protruding amount of the positioning pin 52 becomes maximum (maximum height H1). At this time, the diameter of the positioning pin 52 along the upper surface 511, that is, the diameter of the positioning pin 52 at a point intersecting a virtual plane extended from the upper surface 511 becomes maximum (maximum diameter D1).

FIG. 5B is a perspective view illustrating a state in which the UEA 2 is mounted on the upper surface 511 of the table 50. As illustrated in FIG. 5B, each of four sides 211 to 214 of the outer edge portion of a frame 21 of the UEA 2 is provided with a fitting groove 23 to be fitted to a guide member 45 (FIG. 1) at the time of assembling the fuel cell stack 100. The fitting groove 23 has a pair of recesses 23a and 23b arranged side by side along each of the sides 211 to 214. Although not illustrated, the guide member 45 has a pair of protrusions protruding toward the frame 21, and the pair of protrusions of the guide member 45 is fitted to the pair of recesses 23a and 23b.

The plurality of positioning pins 52 are provided corresponding to positions of the recess 23a of the three sides 211, 212, and 214 of the frame. The width W1 (FIG. 4B) of the recess 23a is, for example, the same as the maximum diameter D1 (FIG. 6) of the positioning pin 52, and the positioning pin 52 is fitted to the recess 23a. As a result, the UEA 2 is set on the table in a state of being positioned with reference to the recesses 23a. The width W1 of the recess 23a may be smaller than the maximum diameter D1.

From the state of FIG. 5B, the border frame 60 made of resin is mounted above the positioning pin 52 so as to cover the positioning pin 52 as illustrated in FIG. 4A The border frame 60 has four frame portions 61 to 64 extending along the sides 211 to 214 of the UEA 2, and has a substantially rectangular frame shape as a whole. The height (length in the up-down direction) of the border frame 60 is higher than the maximum height H1 (FIG. 6) of the positioning pin 52. The three frame portions 61, 62, and 64 are provided with protruding portions 65 that protrude toward the UEA 2 and correspond to the fitting grooves 23 of the UEA 2. Although not illustrated, the shape of the protruding portion 65 in plan view is substantially equal to the shape of the pair of protrusions of the guide member 45 (FIG. 1).

FIG. 4B is an enlarged view of a portion B in FIG. 4A. FIG. 4B also illustrates the separator 3 mounted on the upper surface of the UEA 2. As illustrated in FIG. 4B, the protruding portion 65 has a pair of protrusions 65a and 65b corresponding to the pair of recesses 23a and 23b of the UEA 2. The separator 3 has a pair of recesses 3a and 3b corresponding to the pair of recesses 23a and 23b, and the positioning pin 52 is disposed in the recess 3a.

The width W2 of the recess 3a of the separator 3 is larger than the width W1 of the recess 23a of the UEA 2. More specifically, the width of the recess 3a is equal to the width of the protrusion 65a. As a result, the recess 3a of the separator 3 can be mounted on the upper surface of the UEA 2 while being positioned along a side wall surface 650 of the protrusion 65a rising above the table 50.

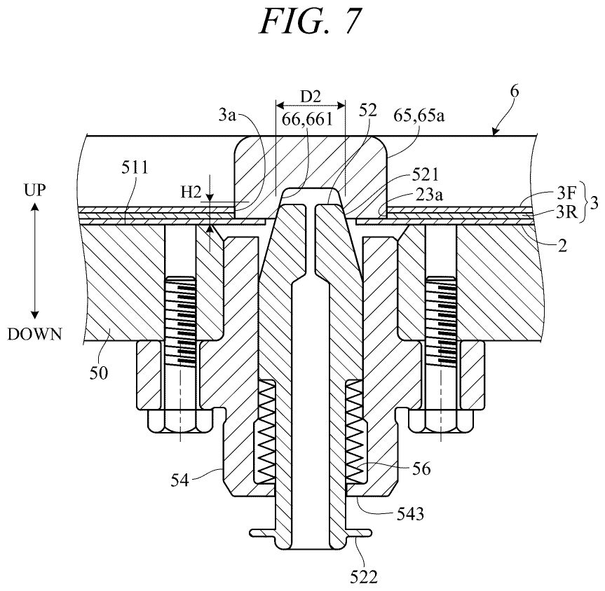

FIG. 7 is a cross-sectional view taken along line VII-VII of FIG. 4B. As illustrated in FIG. 7, bottomed groove 66 which is recessed upward is formed on a bottom surface of the protrusion 65a of border frame 60. The bottomed groove 66 has a truncated cone shape and has an inclined surface 661 having the same inclination angle as the tapered portion 521 of the positioning pin 52. The positioning pin 52 is inserted into the bottomed groove 66 from below. At this time, the inclined surface 661 abuts on the tapered portion 521, whereby a downward pressing force acts on the positioning pin 52. The downward pressing force is generated by the own weight of the border frame 60, but the pressing force is larger than the biasing force of the spring 56. Therefore, the spring 56 is retracted, and the positioning pin 52 is pushed downward.

The positioning pin 52 is pushed until the lower end surface of the protruding portion 65 of the border frame 60 abuts on the upper surface of the UEA 2. In the state of FIG. 7 in which the positioning pin 52 is pushed downward at the maximum, the protruding amount of the positioning pin from the upper surface 511 of the table 50 is shorter than H1 in FIG. 6 and is minimum (minimum height H2). At this time, the diameter of the positioning pin 52 along the upper surface 511 is smaller than D1 in FIG. 6 and is minimum (minimum diameter D2).

The width W1 (FIG. 4B) of the recess 23a of the UEA 2 slightly varies due to dimensional tolerance or the like, but the width W1 is at least larger than the minimum diameter D2. Therefore, even in a case where the width W1 is smaller than the maximum diameter D1 (FIG. 6) of the positioning pin 52 in the initial state, the frame 21 of the UEA 2 can be arranged on the upper surface 511 of the table 50 without strongly interfering with the positioning pin 52. As a result, damage to the frame 21 can be prevented.

A manufacturing method of a cell unit for the fuel cell according to the present embodiment is summarized as follows. First, the UEA 2 is sucked by a hand of a robot (not illustrated) and conveyed above the table 50. Then, as illustrated in FIG. 5B, the recess 23a at the outer edge of the UEA 2 is fitted to the positioning pin 52 protruding from the upper surface 511 of the table 50, and the UEA 2 is disposed on the upper surface 511 of the table 50 or above the upper surface 511 while being positioned with respect to the table 50 (membrane electrode structure disposing processing). Since the UEA 2 is positioned by the positioning pins 52 at three locations around the UEA 2, the position of the UEA 2 can be accurately defined.

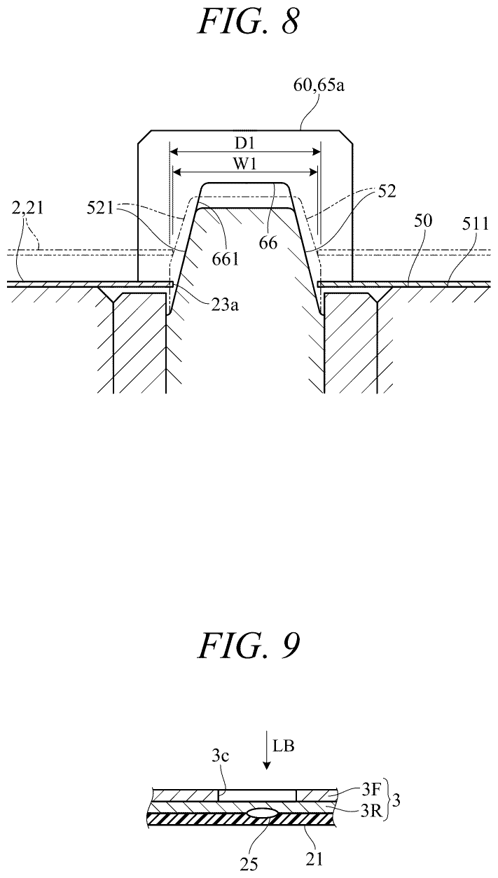

Next, the border frame 60 is held by a hand of a robot (not illustrated), and the border frame 60 is mounted above the positioning pin 52 as illustrated in FIG. 4A (border frame mounting processing). FIG. 8 is a diagram illustrating the position (two-dot chain line) of the positioning pin 52 before the border frame 60 is mounted and the position (solid line) of the positioning pin 52 after the border frame 60 is mounted. As illustrated in FIG. 8, before the border frame 60 is mounted, the positioning pin 52 protrudes upward to the maximum. Therefore, in a case where the width W1 of the recess 23a of the UEA 2 is narrower than the maximum diameter D1 of the positioning pin 52, the edge of the recess 23a of the UEA 2 comes into contact with the tapered portion 521 as indicated by the two-dot chain line in FIG. 8. As a result, the UEA 2 rises from the upper surface 511 of the table 50.

At this time, in a case where the border frame 60 is placed on the upper surface of the positioning pin 52, the positioning pin 52 is inserted into the bottomed groove 66, and before the bottom surface of the border frame 60 comes into contact with the upper surface of the frame 21 of the UEA 2, the inclined surface 661 of the bottomed groove 66 of the protrusion 65a comes into contact with the tapered portion 521 of the positioning pin 52, and the positioning pin 52 is pushed downward. As a result, the diameter of the positioning pin 52 along the upper surface 511 of the table 50 becomes smaller than the maximum diameter D1, and as the positioning pin 52 is moved downward, the UEA 2 can be moved downward until the UEA 2 abuts on the upper surface 511 of the table 50.

After the frame 21 of the UEA 2 is mounted on the upper surface 511 of the table 50, the bottom surface of the border frame 60 abuts on the upper surface of the frame 21. As a result, the UEA 2 can be held in a state of being positioned. The bottom surface of the border frame 60 may float by a predetermined amount from the upper surface of the frame 21. As a result, it is possible to reliably prevent the weight of the border frame 60 from acting on the frame 21.

Next, the separator 3 is sucked by a hand of a robot (not illustrated), and the separator 3 is mounted on the upper surface of the UEA 2 (separator mounting processing). At this time, the separator 3 is mounted on the upper surface of the UEA 2 along the side wall surface 650 (FIG. 4B) while the recess 3a of the separator 3 is positioned by being fitted to the protrusion 65a of the border frame 60. Since the separator 3 is positioned by the protrusion 65a at three locations around the separator 3, the position of the separator 3 can be accurately defined.

Next, in a state where the UEA 2 and the separator 3 are positioned on the table, the frame 21 of the UEA 2 is welded to the separator 3 using a welding machine (not illustrated) (for example, a laser processing machine) (welding processing). The welding (thermal bonding) is performed at a plurality of welding portions of the frame 21, which are determined in advance. The welding portion can be provided, for example, in the vicinity of the fitting groove 23 of the frame 21. The welding portion may be provided in the vicinity of the corner of the frame 21.

FIG. 9 is a cross-sectional view schematically illustrating a configuration of the welding portion. As illustrated in FIG. 9, a through-hole 3c having a substantially circular shape is opened in advance in a front plate 3F of the separator 3 facing a welding portion 25. The welding portion 25 is irradiated with a laser beam LB using a laser processing machine attached to a hand of a robot (not illustrated). That is, the laser beam LB is emitted from above the separator 3 toward a rear plate 3R via the through-hole 3c as indicated by an arrow. As a result, the welding portion 25 is heated, and the rear plate 3R of the separator 3 and the frame 21 can be welded (thermally bonded) via the welding portion 25. In a case where the welding between the UEA 2 and the separator 3 is completed, the manufacture of the cell unit 1a is completed.

At the time of assembling the fuel cell stack 100, the cell unit 1a is sucked by a hand of a robot (not illustrated), and a plurality of cell units 1a are stacked while the cell unit 1a is positioned by fitting the fitting groove 23 (recesses 23a, 23b) of the frame 21 to the guide member 45 installed in a case in advance. By stacking the cell units 1a, the number of movements of the hand of the robot is small and the stacking processing can be completed in a short time as compared with a case where the UEA 2 and the separator 3 are separately stacked.

The width W1 of the recess 23a of the frame 21 of the UEA 2 is narrower than the width of the recess 3a of the separator 3, and the edge of the recess 23a protrudes outward from the edge of the recess 3a. Therefore, it is possible to secure an insulation distance between the pair of separators 3 and 3 arranged in the front-rear direction via the UEA 2. The fitting groove 23 of the frame 21 is fitted to the guide member 45, and the positioning of the cell unit 1a is performed using the recesses 23a and 23b of the frame 21 instead of the recesses 3a and 3b of the separator 3.

According to the present embodiment, the following operations and effects can be achieved.
(1) A cell unit manufacturing method for a fuel cell in which a cell unit 1a is manufactured by integrating the UEA 2, which has the MEA 20 including an electrolyte membrane, an anode electrode, and a cathode electrode, and the frame 21 that is made of resin and supports the MEA 20, with the separator 3 includes following processing. That is, the manufacturing method includes processing (membrane electrode structure disposing processing) of disposing the UEA 2 above the upper surface 511 of the table 50 by fitting the recess 23a of the fitting groove 23 provided in the outer edge portion of the frame 21 to the positioning pin 52 that protrudes from the upper surface 511 of the table 50 to be movable up and down, processing (border frame mounting processing) of mounting the border frame 60 on the positioning pin 52 to push the positioning pin 52 while being positioned by the positioning pin 52, processing (separator mounting processing) of mounting the separator 3 on the UEA 2 while the recess 3a of the separator 3 is positioned by the protrusion 65a provided on the border frame 60, and processing (welding processing) of welding (thermal bonding) the positioned UEA 2 and separator 3 (FIGS. 4A, 4B, 5B, and 9).

As a result, after the UEA 2 is fitted to the positioning pin 52 and mounted on the upper surface 511 of the table 50, the positioning pin 52 is pushed downward by the weight of the border frame 60 before the separator 3 is mounted on the upper surface of the UEA 2. Therefore, the UEA 2 can be reliably installed on the upper surface 511 of the table 50. As a result, when the separator 3 is mounted, it is possible to prevent the weight of the separator 3 from acting on the UEA 2 in a state where the UEA 2 floats from the upper surface of the table 50, and it is possible to prevent damage to the recess 23a for positioning of the frame 21.
(2) A cell unit manufacturing apparatus for a fuel cell in which a cell unit 1a is manufactured by integrating the UEA 2, which has the MEA 20 including an electrolyte membrane, an anode electrode, and a cathode electrode, and the frame 21 that is made of resin and supports the MEA 20, with the separator 3 includes a following configuration. That is, the manufacturing apparatus includes the table 50 that includes the upper surface 511 where the UEA 2 is installed, and the positioning pin 52 protruding from the upper surface 511 to be fitted into the recess 23a provided on the outer edge portion of the frame 21; and the border frame 60 that includes the bottomed groove 66 that abuts on the positioning pins 52 while being positioned by the positioning pin 52, and the protrusion 65a that positions the separator 3, and is mounted on the positioning pin 52 via the bottomed groove 66 (FIGS. 4A, 4B, and 5B). The table 50 further includes the holder 54 that movably supports the positioning pin 52 in the up-down direction, allowing the positioning pin 52 to move downward when the border frame 60 is mounted via the bottomed groove 66 (FIGS. 6 and 7).

With this configuration, since the positioning pin 52 is moved downward when the border frame 60 is mounted, the UEA 2 can be reliably installed on the upper surface 511 of the table 50 before the separator 3 is mounted on the upper surface of the UEA 2. As a result, it is possible to prevent the weight of the separator 3 from acting on the UEA 2 in a state where the UEA2 floats from the upper surface 511 of the table 50. As a result, it is possible to prevent the frame 21 from being cracked starting from the recess 23a, and it is possible to favorably manufacture the cell unit 1a.
(3) The border frame 60 has the side wall surface 650 that extends in a substantially U shape along the outer edge of the separator 3 so as to surround the bottomed groove 66 and functions as the positioning portion (FIG. 4B). The positioning pin 52 is inserted into the bottomed groove 66, and the surface of the bottomed groove 66 abuts on the positioning pin 52. However, since the side wall surface 650 extends to surround the bottomed groove 66, the recess 23a of the frame 21 fitted to the positioning pin 52 protrudes to the outside of the recess 3a of the separator 3 beyond the side wall surface 650. Therefore, at the time of assembling the fuel cell stack 100, the recess 23a of the frame 21 is fitted to the guide member 45 (FIG. 1) to function as the positioning portion of the cell unit 1a. As a result, it is possible to secure an insulation distance between the pair of separators 3 and 3 arranged in the front-rear direction with the UEA 2 interposed therebetween. In addition, since the recesses 3a and 3b of the separator 3 are disposed in the vicinity of the recesses 23a and 23b of the frame 21, the rigidity of the recesses 23a and 23b of the frame 21 can be enhanced.
(4) The positioning pin 52 has the tapered portion 521 formed to narrow upward at the upper end portion thereof so as to form a gap with protrusion 65a of the frame 21 when the positioning pin 52 is pushed downward via the bottomed groove 66 (FIG. 7). As a result, a pressing force can be uniformly applied to the positioning pin 52 in the circumferential direction via the bottomed groove 66. In addition, when the positioning pin 52 is pushed down, the UEA 2 can be reliably placed on the upper surface 511 of the table 50.

The above embodiment can be modified in various forms. Below, some modified examples are described. In the above embodiment, the recess 23a is provided as a positioned portion on the outer edge of the resin frame 21 (a frame member) supporting the MEA 20, and the recess 23a is fitted to the positioning pin 52. However, the positioned portion may be a through hole instead of a groove. In the above embodiment, the positioned portion is fitted to the positioning pin, but it may be engaged instead of fitted. Although in the above embodiment, the tapered portion 521 is provided at the upper end of the positioning pin 52, the configuration of a positioning member is not limited to the above.

In the above embodiment, the inclined surface 661 of the bottomed groove 66 of the border frame 60 abuts on the tapered portion 521 of the positioning pin 52. However, the configuration of an abutting portion is not limited to the above. In the above embodiment, the separator 3 is positioned relative to the border frame 60 by the side wall surface 650 of the protrusion 65a. However, the configuration of a positioning portion is not limited to the above. Positioning of the separator 3 may be performed at a location different from where the positioning pin is installed (e.g., at the corner where each side 311 to 314 of the separator 3 intersects). Therefore, the recesses 3a and 3b of the separator 3 may not be necessary. That is, as long as there is an abutting portion that abuts on the positioning member while being positioned by the positioning member, and a positioning portion for positioning the separator, the configuration of a positioning frame is not limited to the above-mentioned border frame 60 and may be any configuration.

In the above embodiment, the positioning pin 52 is supported to be movable up and down by the holder 54 provided on the table 50, but the configuration of a support portion is not limited to the above. As long as there is an upper surface where the membrane electrode structure is installed, a positioning member protruding from this upper surface, and a support portion that supports the positioning member to be movable up and down, the configuration of a table may be any configuration. Although in the above embodiment, the guide member 45 is supported by the case 30, it may be supported by a pair of end units 40. For example, a recess or through hole may be provided in the end unit 40 to support both front and rear ends of the guide member 45. The cross-sectional shape of the guide member is not limited to the above, and may be, for example, substantially circular.

The above embodiment can be combined as desired with one or more of the above modifications. The modifications can also be combined with one another.

According to the present invention, it is possible to manufacture a cell unit satisfactorily without damaging a frame member of a membrane electrode structure.

Above, while the present invention has been described with reference to the preferred embodiments thereof, it will be understood, by those skilled in the art, that various changes and modifications may be made thereto without departing from the scope of the appended claims.

What is claimed is:

1. A cell unit manufacturing method for a fuel cell, a cell unit being configured by joining together a membrane electrode structure and a separator, the membrane electrode structure including a membrane electrode assembly having an electrolyte membrane and an electrode, and a frame member being made of resin and configured to support the membrane electrode assembly, the cell unit manufacturing method comprising:
disposing the membrane electrode structure above an upper surface of a table by engaging or fitting a positioned portion provided on an outer edge of the frame member with a positioning member formed in a rod shape, the positioning member being protruding movably upward and downward from the upper surface of the table;
mounting a positioning frame on the positioning member to push the positioning member while positioning the positioning frame using the positioning member;
mounting the separator on the membrane electrode structure while positioning an outer edge of the separator using a positioning portion provided on the positioning frame; and
welding the membrane electrode structure and the separator in a state where the membrane electrode structure and the separator are positioned.

2. The cell unit manufacturing method according to claim 1, wherein
the mounting the positioning frame including pushing the positioning member with the positioning frame to lower the membrane electrode structure and dispose the membrane electrode structure onto the upper surface of the table.

3. A cell unit manufacturing apparatus for a fuel cell, a cell unit being configured by joining together a membrane electrode structure and a separator, the membrane electrode structure including a membrane electrode assembly having an electrolyte membrane and an electrode, and a frame member being made of resin and configured to support the membrane electrode assembly, the cell unit manufacturing apparatus comprising:
a table including an upper surface onto which the membrane electrode structure is disposed, and a positioning member formed in a rod shape, the positioning member protruding from the upper surface so that a positioned portion provided on an outer edge of the frame member is engaged or fitted with the positioning member; and
a positioning frame including an abutting portion abutting on the positioning member and positioned by the positioning member, and a positioning portion configured to position the separator, the positioning frame being mounted on the positioning member through the abutting portion, wherein
the table further includes a support portion supporting the positioning member so as to allow vertical movement so that the positioning member lowers when the positioning frame is mounted through the abutting portion.

4. The cell unit manufacturing apparatus according to claim 3, wherein
the positioning frame includes a side wall surface extending along an outer edge of the separator so as to surround the abutting portion and functioning as the positioning portion.

5. The cell unit manufacturing apparatus according to claim 3, wherein
the positioning member includes a tapered portion at an upper end, the tapered portion being formed to narrow upward.

6. The cell unit manufacturing apparatus according to claim 3, wherein
the positioning frame includes a frame part surrounding the separator and a protruding portion protruding inward from an inner edge of the frame part, and
the abutting portion is provided on a bottom surface of the protruding portion.

7. The cell unit manufacturing apparatus according to claim 6, wherein
the frame part includes four sides, and
the positioning member is provided at three positions of the table corresponding to three sides of the four sides.
